(19) United States
(12) Patent Application Publication
(10) Pub. No.: US 2006/0215219 A1
(43) Pub. Date: Sep. 28, 2006

(54) Printing system, image reading apparatus and control method therefor

(75) Inventors: Kouji Yorimoto, Saitama (JP); Katsuo Shimizu, Saitama (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/211,754

(22) Filed: Aug. 26, 2005

(30) Foreign Application Priority Data
Mar. 23, 2005 (JP) 2005-084172

(51) Int. Cl. G06F 3/12

(52) U.S. Cl. 358/1.15

(57) ABSTRACT

In a printing system comprising an image reading apparatus and plural printers, the image reading apparatus holds functional characteristics information of the printers, selects a printer most suitable for printing the information that has been read based on the functional characteristics information of the printers, prepares print data by writing the information that has been read in a page description language which can be interpreted by the selected printer, and sends the print data to the selected printer. On receiving the print data, the selected printer interprets the page description language in the print data, and executes print processing.

### BACKGROUNG OF THE INVENTION

1. Field of the Invention

The present invention relates to a printing system having an image reading apparatus that reads information from an original document, and plural printers that print out the information read by the image reading apparatus, an image reading apparatus employed in the print system, and a control method for the print system. Particularly, the present invention relates to a printing system designed to automatically select a printer to print out an original document based on information on the condition of the original document (e.g., color information and size information), an image reading apparatus employed in such a printing system, and a control method for the print system.

2. Description of the Related Art

In recent years, a trend of price reduction for OA (Office Automation) equipment such as copying machines and multi-function copiers has been kept going, which prompts hardware makers providing such OA equipment to take measures to cope with this trend of price reduction.

As one of such measures, there has been proposed a scanner/printer system (printing system) in which a scanner is linked to a printer to perform print processing including copying.

Such printing system has advantages that, in addition to that print processing including copying can be performed with a simple structure, the cost for introducing the printing system can be reduced significantly in comparison with the cost for introducing a multi-function copier or a copying machine.

Conventional techniques relating to this kind of printing systems are described in Japanese Patent Application Publication Nos. 2002-044327 and 2004-015696. Of these publications, Japanese Patent Application Publication No. 2002-044327 discloses a technique capable of selecting, from among plural printers connected to a scanner, a most suitable printer for a read image.

On the other hand, Japanese Patent Application Publication No. 2004-015696 discloses a technique which enables to mount either a color printer or a monochrome printer on a color scanner, whereby an efficient system suitable for a user's use situation can be established.

According to the technique described in the Japanese Patent Application Publication No. 2002-044327, for an image read by a monochrome scanner, a control is performed to select a printer that is suitable for the read image. Thus, a monochrome printer is selected to print out the image, or a color printer is selected to print out the image in the monochrome print mode.

However, according to such control, a printer to which print data is to be sent is selected depending on whether the reading is performed by a color scanner or a monochrome scanner. In other words, the printer is selected independent of whether the original document is monochrome or color.

Therefore, if a monochrome original document is read by a color scanner, a color printer will be automatically selected as a printer to which print data is to be sent even if the original document is then to be printed out in monochrome. This cannot be said to be an optimal printer selection.

According to the technique described in the Japanese Patent Application Publication No. 2004-015696, whether the printer connected to the scanner is a color printer or a monochrome printer is detected, and if an original document image data is read by the scanner in color, a color printer is selected to print out the image data based on the detection of the printer. This means that the technique of the Japanese Patent Application Publication No. 2004-015696 selects a printer to which print data is to be sent independent of the condition of the original document, and thus will pose similar problem to the technique of the Japanese Patent Application Publication No. 2002-044327.

### SUMMARY OF THE INVENTION

The present invention has been made in view of the above circumstances and provides a printing system which is designed to automatically select a printer to print out an original document based on information on the condition of the original document (e.g., color information and size information), an image reading apparatus used in such printing system, and a control method therefor.

According to an aspect of the present invention, a printing system comprises an image reading apparatus that reads information from an original document; and a plurality of printers that performs printing based on the information read by the image reading apparatus, wherein the image reading apparatus comprises an image reading unit that reads information from the original document; a printer characteristics holding unit that holds functional characteristics information of the printers; a selecting unit that selects a printer most suitable for printing the information read by the image reading unit, based on the functional characteristics information of the printers held by the printer characteristics holding unit; a print data processing unit that prepares print data by writing the information read by the image reading unit in a page description language which can be interpreted by the selected printer; and an output control unit that sends the print data prepared by the print data processing unit to the printer selected by the selecting unit, and wherein the printer selected by the selecting unit receives the print data sent by the output control unit, interprets the page description language in the print data, and executes print processing.

With the above configuration, a printer most suitable for printing out information read from an original document is selected based on functional characteristics information of printers, so that the information read from the original document is printed out by the selected printer. Therefore, a most suitable printer can be used to conduct print (copy) processing in linkage to the image reading apparatus, while the user is not required to pay attention to specifications or performance of the printers. Additionally, the user is not required to designate a printer every time the image reading apparatus reads an original document, and thus the operation can be simplified.

### BRIEF DESCRIPTION OF THE DRAWINGS

Embodiments of the present invention will be described in detail based on the following figures, wherein:

FIG. 1 is a block diagram illustrating an example of an overall configuration of a printing system according to the present invention;

FIG. 2 is a block diagram illustrating an internal configuration of a scanner 10 shown in FIG. 1 according to a first embodiment of the present invention;

FIG. 3 illustrates an example of a layout of a printer characteristics table 13 according to the first embodiment;

FIG. 4 is a flowchart illustrating operations of a printing system according to the first embodiment;

FIG. 5 is a block diagram illustrating an internal configuration of a scanner 10 according to a second embodiment of the present invention;

FIGS. 6A and 6B respectively illustrate examples of layout of a printer characteristics table 13 and a printer group information table 17 according to the second embodiment;

FIG. 7 is a flowchart illustrating operations of the printing system according to the second embodiment;

FIG. 8 is a block diagram illustrating an internal configuration of a scanner 10 according to a third embodiment of the present invention;

FIG. 9 is a flowchart illustrating operations of the printing system according to the third embodiment;

FIG. 10 shows a modification of the scanner 10 according to the present invention;

FIG. 11 shows a modification of the layout of the printer characteristics table 13 according to the present invention; and

FIG. 12 shows another modification of the scanner 10 according to the present invention.

### DETAILED DESCRIPTION OF THE EMBODIMENTS

Description will now be made of embodiments of a printing system, an image reading apparatus and a control method therefor according to the present invention, with reference to the accompanying drawings.

### First Embodiment

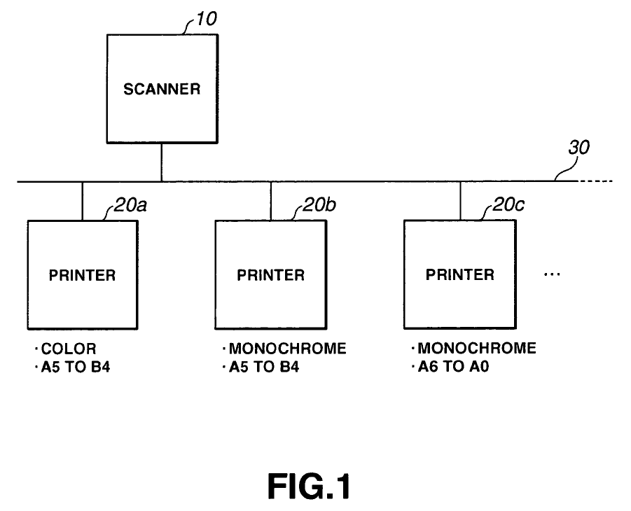

FIG. 1 is a block diagram illustrating an example of an overall configuration of a printing system according to the present invention.

The printing system as shown in FIG. 1 comprises a scanner 10, and plural printers 20a, 20b and 20c (hereafter, the printers 20a, 20b and 20c are to be collectively referred to as the “printers 20”) connected to the scanner 10 by means of a LAN (Local Area Network) 30. Although the following description will be made of a case in which the scanner and the printers are connected by means of the LAN 30, they may be connected by any means other than the LAN as long as the functions of the present invention can be implemented.

The scanner 10 is an image reading apparatus which scans an original document placed on a platen glass to read graphics, photographs, or characters from the original document, and converts them to digital data. The original document image data thus read is sent to one of the printers 20 so that the printer 20 performs print processing of the image data.

The scanner 10 has therein a printer characteristics table described later in detail. Using this table, the scanner 10 recognizes functional characteristics of the respective printers 20, selects a printer 20 most suitable for printing out the read original document based on information on the original document such as color or monochrome and paper size, and sends the print data to the selected printer 20. For example, when the read original document is color, the print data is sent to a printer 20a which is capable of color printing.

Each of the printers 20 is a printer which receives the print data sent from the scanner 10, interprets a page description language in the print data, and performs the print processing. The printers 20 are capable of performing the copy function by being linked with the scanner 10 to print out the original document image data read by the scanner 10.

The printers 20 respectively have various functional characteristics. Some printers are capable of color printing, and some printers are capable of printing on paper of a large size such as A0 or A1. For example, as shown in FIG. 1, the printer 20a is a color printer and is capable of printing on A5 to B4 size paper. The printer 20b and the printer 20c are monochrome printers not capable of color printing. The printer 20c is capable of printing on paper of a wide variety of sizes from A6 to A0.

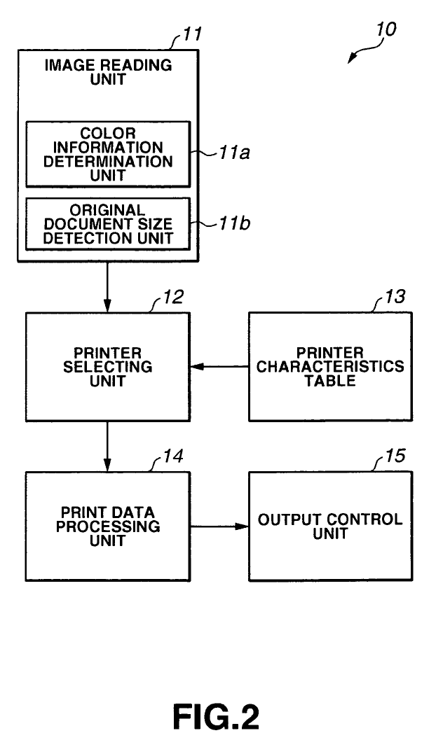

FIG. 2 is a block diagram illustrating an internal configuration of the scanner 10 shown in FIG. 1. The following description will be made only of constituent elements relating to the present invention.

The scanner 10 includes, as processing functional units, an image reading unit 11, a printer selecting unit 12, a printer characteristics table 13, a print data processing unit 14, and an output control unit 15.

The image reading unit 11 is a processing unit that reads information (original document image data) from an original document. The image reading unit 11 has therein a color information determination unit 11a which determines whether original document image data read from an original document is color or monochrome, and an original document size detection unit 11b which detects a size of the read original document. The determination result by the color information determination unit 11 a is notified to the printer selecting unit 12 as color information (monochrome or color), and the original document size detected by the original document size detection unit 11b is notified thereto as size information.

The printer selecting unit 12 is a processing unit that searches the printer characteristics table 13 based on the color information and the size information received from the image reading unit 11 and selects a printer 20 most suitable for printing out the read original document. For example, when the read original document is a monochrome document and the size thereof is A1, the printer 20c which is capable of color printing and capable of printing on A1-size paper will be selected.

The printer selecting unit 12 may select a printer 20 suitable for printing out the read original document not only based on both the color information and the size information from the color information determination unit 11a and the original document size detection unit 11b, but also based on either one of them.

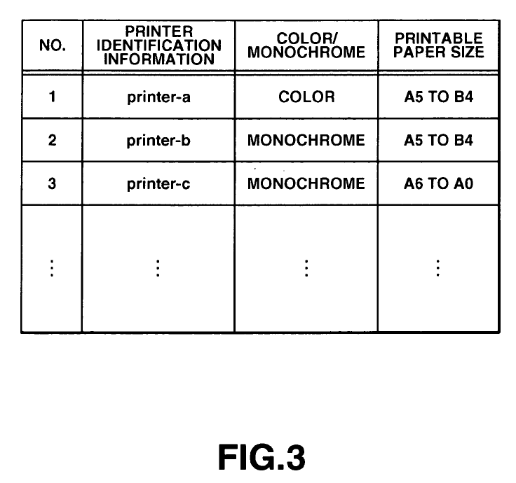

The printer characteristics table 13 is a table which holds the functional characteristics information of the printers 20. Specifically, as shown in FIG. 3, functional characteristics such as color or monochrome, and printable paper size of each printer are stored in association with printer identification information for identifying the respective printers 20.

The print data processing unit 14 is a processing unit that prepares print data written in a page description language. Specifically, the print data processing unit 14 prepares print data by writing the original document image data read by the image reading unit 11 in a page description language, which can be interpreted by the printer 20 selected by the printer selecting unit 1.

The output control unit 15 is a processing unit that sends the print data including the original document image data prepared by the print data processing unit 14, to the printer 20 selected by the printer selecting unit 12. Upon receiving the print data from the output control unit 15, the printer 20 interprets the page description language in the print data and performs printing processing for the original document image data. These are the descriptions of the functional blocks forming the internal configuration of the scanner 10 according to the present invention.

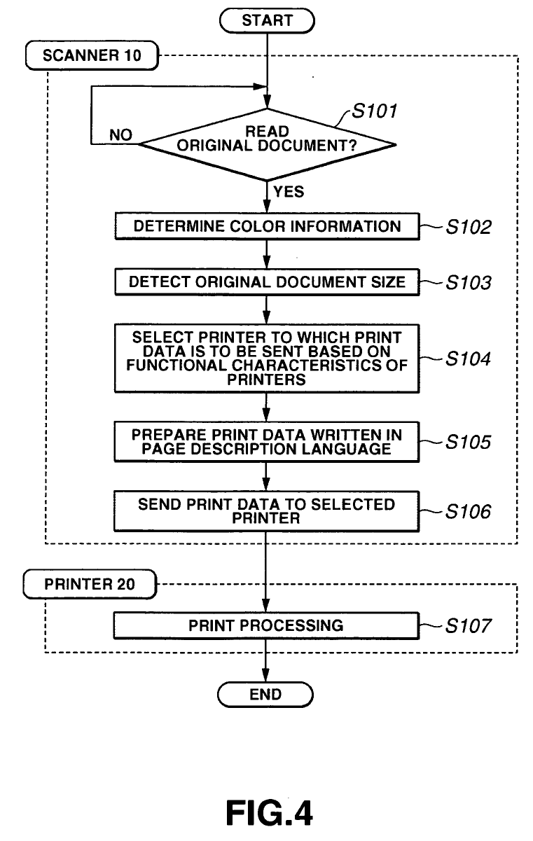

FIG. 4 is a flowchart illustrating operations of the printing system according to the first embodiment.

When the user places an original document on the platen glass of the scanner 10 and presses a start button (not shown), the original document is read (YES in step S101), and the processing is started.

When the original document image data is read from the original document by the image reading unit 11 of the scanner 10, the color information determination unit 11a determines whether the original document image data is color or monochrome (step S102), while the original document size detection unit 11b detects the size of the original document (step S103).

When various information (color information and size information) is read from the original document, the printer selecting unit 12 searches the printer characteristics table 13 based on the color information and the size information to select a printer 20 which is suitable for printing out the read original document (step S104).

Upon selection of a printer 20 by the printer selecting unit 12, the print data processing unit 14 prepares print data written in a page description language which can be interpreted by the selected printer 20 (step S105).

The print data including the original document image data thus prepared is sent by the output control unit 15 to the printer 20 selected by the printer selecting unit 12 (step S106). Upon receiving the print data, the printer 20 interprets the page description language in the print data to perform print processing for the original document image data (step S107), and the processing is terminated.

According to the first embodiment as described above, one of the printers 20 suitable for printing information (color information and size information) read from an original document is selected based on functional characteristics of the printers 20, so that the selected printer 20 performs print processing of the original document image data read from the original document. Therefore, the print (copy) processing can be performed by the most suitable printer 20 which is linked with the scanner 10, and the user is not required to pay attention to specification or performance of the printers 20. Further, the user is saved from the trouble of designating one of the printers 20 every time an original document is read by the scanner 10, and the operation can be simplified.

### Second Embodiment

In a second embodiment, the scanner 10 of the first embodiment above is further provided with a user authentication function so that a most suitable printer 20 is selected based on the functional characteristics of the printers 20 and the user who has been authenticated. Since the overall configuration of the print system according to the second embodiment is the same as that of the first embodiment shown in FIG. 1, the description thereof will be omitted. The following description will be made only of a functional configuration and operation thereof.

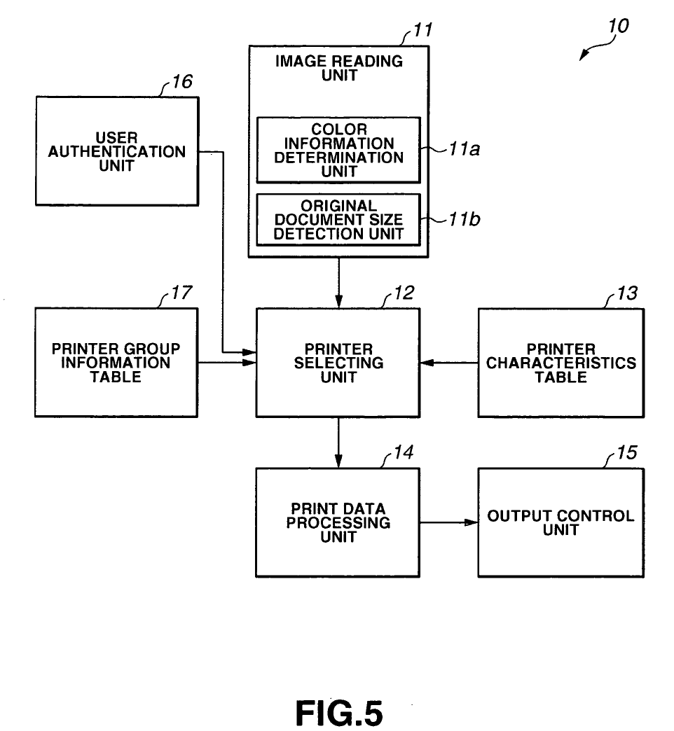

FIG. 5 is a block diagram illustrating an internal configuration of a scanner 10 according to the second embodiment. Those elements assigned with the same reference numerals as those of FIG. 2 illustrating the first embodiment operate substantially in a similar manner to those of the first embodiment. Therefore, description of some of those elements will be omitted.

The scanner 10 further includes a user authentication unit 16 and a printer group information table 17 in addition to the processing functional units of the first embodiment.

The user authentication unit 16 is a processing unit that authenticates a user before reading an original document. Specifically, when an original document is to be read by the scanner 10, the user is authenticated by the authentication unit 16 prior to the reading. The read processing of the original document is initiated after the user has been authenticated.

The user authentication processing by the user authentication unit 16 may be implemented either with the use of a card containing user identification information, or by entering the name and password of the user.

The printer selecting unit 12 searches the printer group information table 17 based on the user authenticated by the user authentication unit 16 to select a printer group which is located close to the user terminal before searching the printer characteristics table 13 to select a printer 20 suitable for printing out the read original document. This means that a printer 20 most suitable for printing out the read original document is selected from among printers 20 which are located close to the terminal of the user who has been authenticated.

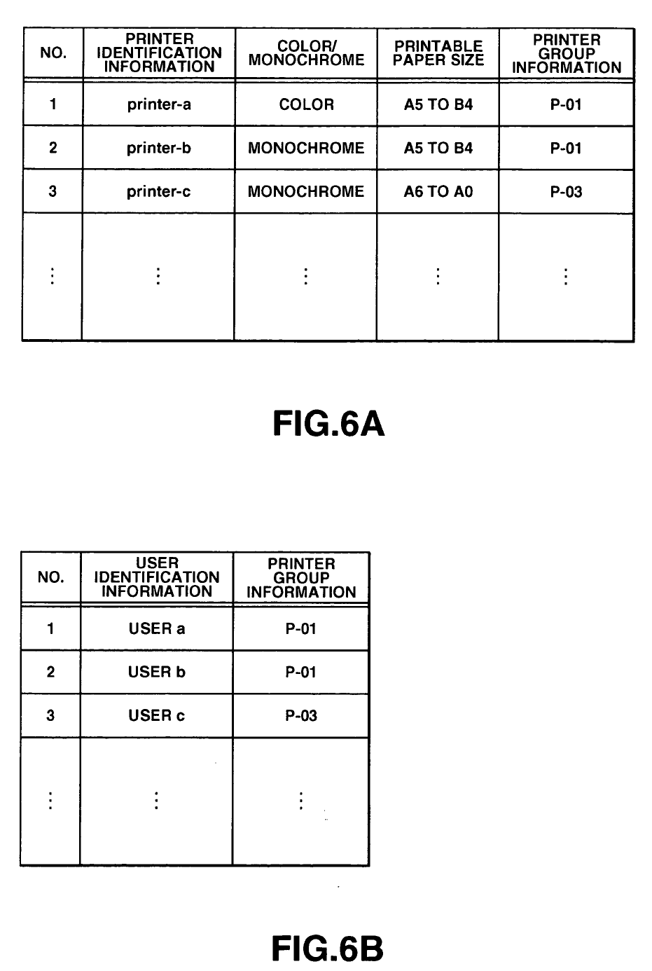

Referring to FIG. 6A, the printer characteristics table 13 holds functional characteristics of the printers such as color/monochrome and printable paper size, and printer group information, in correspondence to printer identification information for identifying the printers 20. In other words, the printer characteristics table 13 is formed by adding the printer group information to the printer characteristics table of FIG. 3 showing the first embodiment.

The printer group information is information for identifying groups of printers 20 which are divided into plural groups based on a predetermined similarity. The predetermined similarity in the present embodiment is related to locations where the printers 20 are installed. The printers 20, which are assigned with same printer group information, are installed at locations close to each other. More specifically, with reference to FIG. 6A, the printer-a and the printer-b are both assigned with the same printer group information P-01, which means that these printers 20 are installed at locations close to each other.

The printer group information table 17 is a table which holds printer group information in correspondence to the respective users. Specifically, as shown in FIG. 6B, the printer group information is held in correspondence to the user identification information for identifying the respective users. The printer group information held in the printer group information table 17 is identical to the printer group information held in printer characteristics table 13. The printer selecting unit 12 thus searches the printer characteristics table 13, using the printer group information obtained from the printer group information table 17 as a key, to narrow down candidate printers to which print data is to be sent the print data.

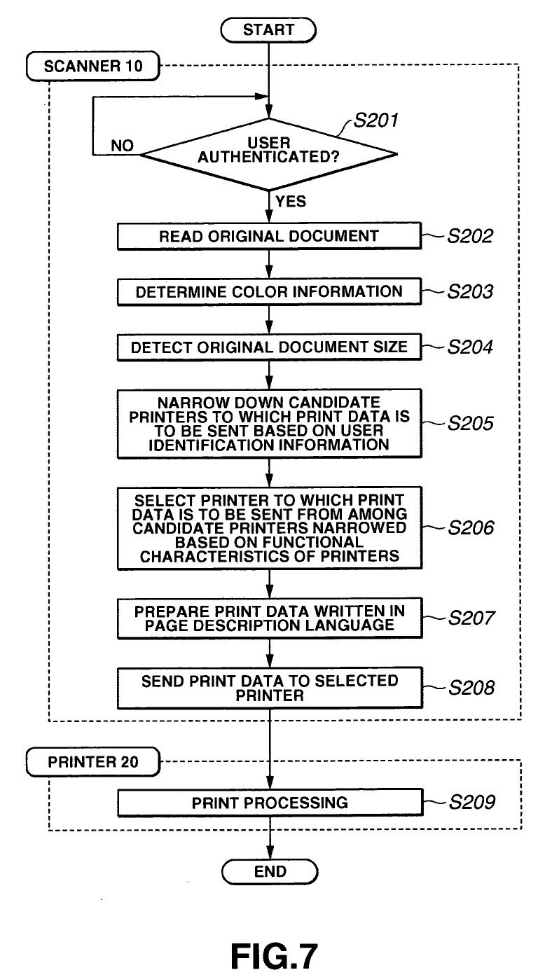

FIG. 7 is a flowchart illustrating operation of the print system according to the second embodiment of the present invention.

When a user is authenticated with the use of a card containing user identification information or by entering the name and password of the user (YES in step S201), the processing is started.

Upon the processing being started, the user authentication result (user identification information) is first notified from the user authentication unit 16 to the printer selecting unit 12. When the user then places an original document on the platen glass of the scanner 10 and presses the start button (not shown), the read processing is performed for the original document (step S202).

When original document image data is read from the original document by the image reading unit 11 of the scanner 10, the color information determination unit 11a determines whether the original document image data is color or monochrome (step S203), while the original document size detection unit 11b detects the side of the original document (step S204).

When the read processing of the original document has been done in this manner, the printer selecting unit 12 performs printer selecting processing. In the printer selecting processing, the printer group information table 17 is first searched based on the user identification information to find a printer group (printer group information) which is located close to the user terminal (step S205). This means that candidate printers 20 to print out the data are narrowed down to the printers located close to the user terminal.

Upon the candidate printers being narrowed down, the printer characteristics table 13 is searched based on the color information and the size information read from the original document to select, from among the candidate printers 20, a printer 20 most suitable for printing out the read original document (step S206).

Upon the printer 20 being selected by the printer selecting unit 12, the print data processing unit 14 prepares print data written in a page description language which can be interpreted by the selected printer 20 (step S207).

The print data containing the original document image data thus prepared is sent from the output control unit 15 to the printer 20 selected by the printer selecting unit 12 (step S208). Upon receiving the print data, the printer 20 interprets the page description language in the print data to perform print processing of the original document image data (step S209), and the processing is terminated.

According to the second embodiment as described above, the scanner 10 is further provided with the user authentication function (user authentication unit 16) in addition to the constituent elements of the first embodiment, which enables the scanner 10 to select a printer 20 to print out, in consideration of locations where the printers 20 are installed in addition to the functional characteristics of the printers 20. Therefore, it is possible to select a more suitable printer 20 to implement print (copy) processing in linkage to the scanner 10.

### Third Embodiment

In a third embodiment of the present invention, the scanner 10 of the first embodiment is additionally provided with the function to inquire for status information of the printers 20, so that a most suitable printer 20 to perform print processing is selected based on the status information of the printers 20 in addition to the functional characteristics of the printers 20. Since the overall configuration of the print system according to the third embodiment is the same as that of the first embodiment shown in FIG. 1, the description thereof will be omitted. The following description will be made only of a functional configuration and operation thereof.

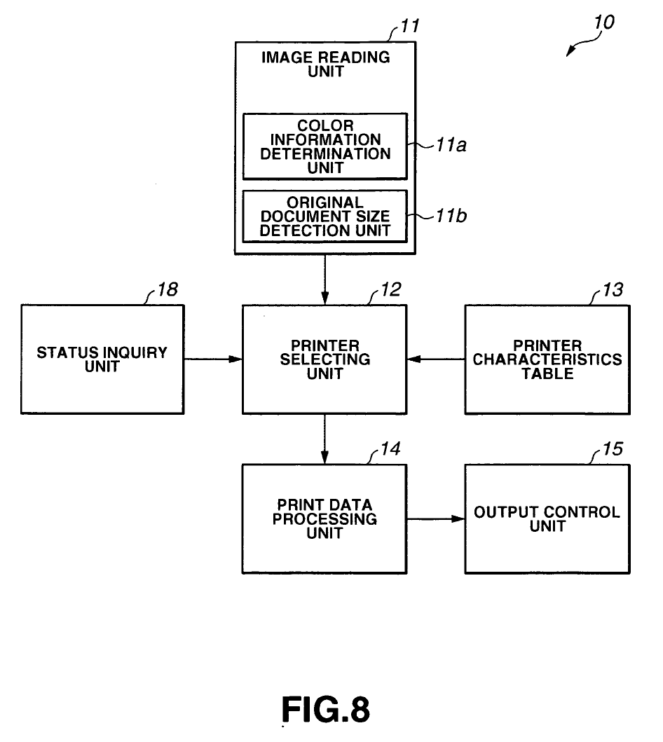

FIG. 8 is a block diagram illustrating an internal configuration of the scanner 10 according to the third embodiment. Those elements assigned with same reference numerals with those of FIG. 2 illustrating the first embodiment operate substantially in a similar manner to the second embodiment. Therefore, description of some of those elements will be omitted.

The scanner 10 includes a status inquiry unit 18 in addition to the processing functional units of the first embodiment.

The status inquiry unit 18 is a processing unit that inquires of the printers 20 for their status information. The status information is information which indicates the operational status of the printer 20 such as “starting up”, “standby for printing”, “printing”, “paper run-out”, “paper jam”, “power on” or “power off”.

The printer selecting unit 12 narrows candidate printers 20 to print out based on the status information obtained by the status inquiry unit 18 before searching the printer characteristics table 13 to select a printer 20 suitable for printing out the read original document. More specifically, all the printers 20 in the operational status other than in the standby status are excluded based on the status information from the inquiry unit 18, so as to narrow down the printers 20 to those which are ready to perform print processing. The printer characteristics table 13 is then used to select a printer 20 suitable for printing out the read original document, from among the printers thus narrowed down.

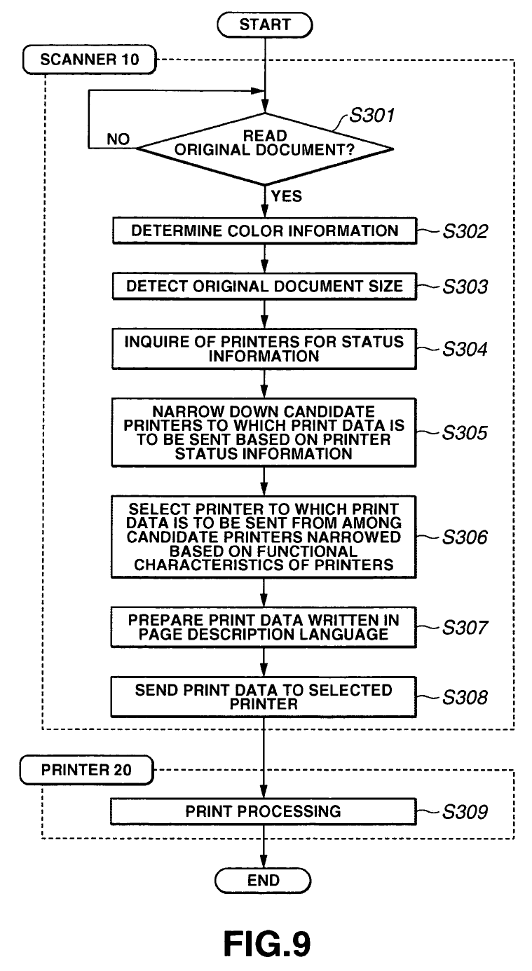

FIG. 9 is a flowchart illustrating operation of the printing system according to the third embodiment.

When the user places an original document on the platen glass of the scanner 10 and presses a start button (not shown), the read processing for the original document is performed (YES in step S301), and the processing is started.

When original document image data has been read from the original document by the image reading unit 11 of the scanner 10, the color information determination unit 11a determines whether the original document image data is color or monochrome (step S302), while the original document size detection unit 11b detects the size of the original document (step S303).

When the read processing has been performed for the original document in this manner, the status inquiry unit 18 inquires of each of the printers 20 for status information thereof (step S304). The result of this inquiry is notified to the printer selecting unit 12 so that the printer selecting unit 12 narrows down candidate printers 20 to print out, based on the status information (step S305). Specifically, all the printers in the operational status other than the standby status are excluded based on the status information, so as to narrow down the candidate printers 20 to those which are ready to perform print processing.

Upon the candidate printers being narrowed down, the printer characteristics table 13 is searched based on the color information and the size information read from the original document to select a printer 20 suitable for printing out the read original document from among the candidate printers 20 thus narrowed down (step S306).

When a suitable printer 20 has been selected by the printer selecting unit 12, the print data processing unit 14 prepares print data written in a page description language which can be interpreted by the selected printer 20 (step S307).

The print data containing the original document image data thus prepared is sent from the output control unit 15 to the printer 20 selected by the printer selecting unit 12 (step S308). Upon receiving the print data, the selected printer 20 interprets the page description language in the print data to perform print processing of the original document image data (step S309), and the processing is terminated.

According to the third embodiment as described above, the printing system is further provided with the function to inquire of the printers 20 for their status information, in addition to those of the first embodiment above. Therefore, a suitable one of the printers 20 can be selected in consideration not only of the functional characteristics of the printers 20 but also of the operational statuses of the printers 20. This makes it possible to select a more suitable printer 20 to perform print (copy) processing in linkage to the scanner 10.

It should be understood that the present invention is not limited to the embodiments described above and illustrated in the accompanying drawings, but may be otherwise variously embodied without departing from the scope of the invention. Some examples of modified embodiments of the print system according to the present invention will be described below.

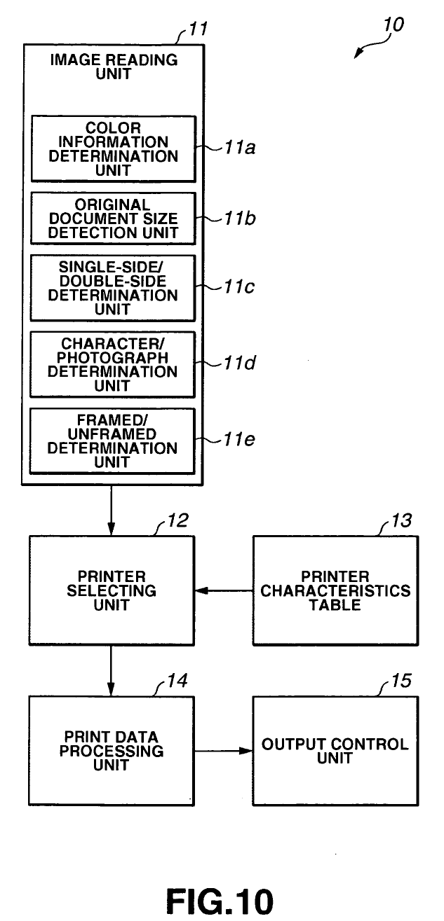

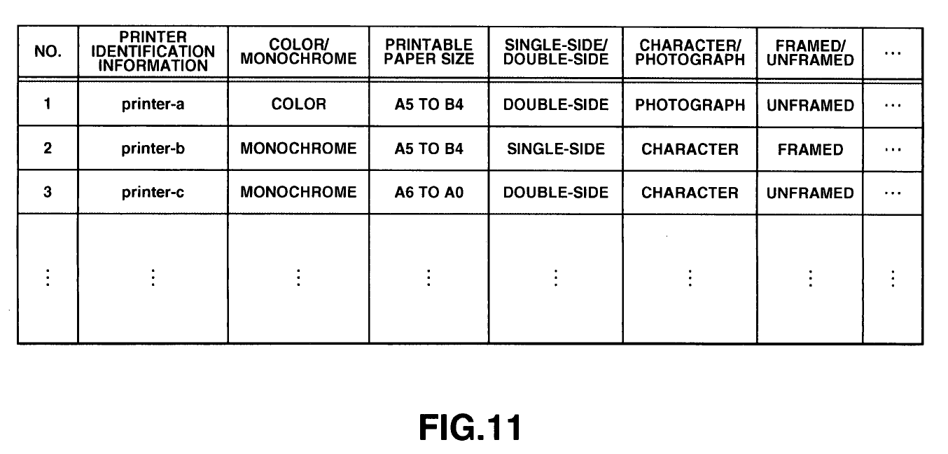

(a) The description of the first to third embodiments above has been made of a case in which a suitable one of the printers 20 is selected based on the color information and the size information read from the original document. As shown in FIG. 10, however, the image reading unit 11 of the scanner 10 may include therein, in addition to the color information determination unit 11a and the original document size detection unit 11b, a single-side/double-side determination unit 11c which determines whether the read original document is a single-sided document or a double-sided document, a character/photograph determination unit 11d which determines whether the read original document data is composed of character information or of images such as photographs, and a framed/unframed determination unit 11e which determines whether the read original document has a margin (frame) or not, so that these processing units are used to select a printer 20 based on the information read from the original document. In this case, the printer characteristics table 13, as shown in FIG. 11, holds functional information of the printers such as color/monochrome, printable paper size, single-side/double-side, character/photograph, and framed/unframed, in correspondence to the printer identification information. When the printer selecting unit 12 selects a printer 20 suitable for printing out the read original document, the selection may be performed either based on the results obtained by all of these processing units, or based on the result obtained by some of these processing units.

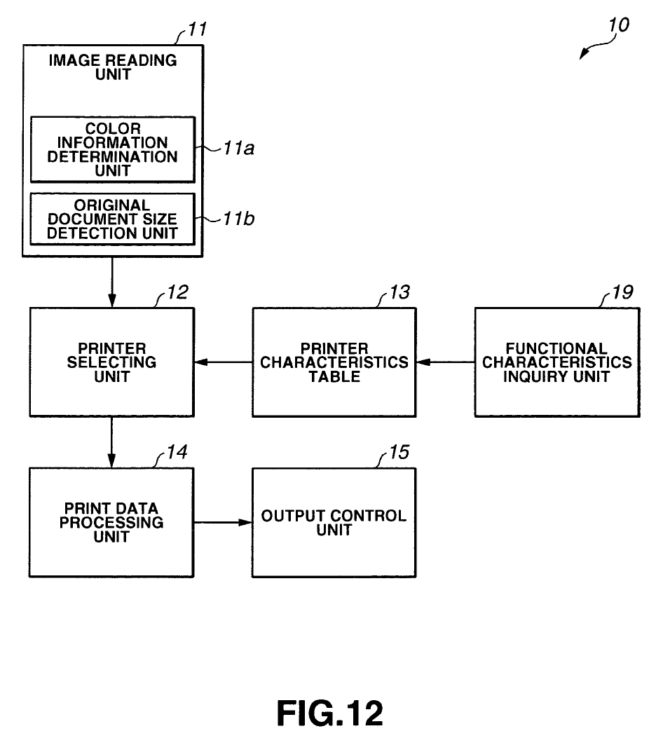

(b) As shown in FIG. 12, the scanner 10 according to the first embodiment shown in FIG. 2 may be further provided with a functional characteristics inquiry unit 19 which inquires of the printers 20 for their functional characteristics information, so that the functional characteristics inquiry unit 19 automatically inquires of the printer 20 for their functional characteristics information, and the inquiry results are stored (updated) in the printer characteristics table 13. In this case, the need of manually updating the printer characteristics table 13 is eliminated, and the functional characteristics information in the printer characteristics table 13 always matches the actual functional characteristics of the printers 20. This modification is of course also applicable to the scanner 10 of FIG. 5 illustrating the second embodiment and the scanner 10 of FIG. 8 illustrating the third embodiment.

The printing system according to the present invention has been described using the first to third embodiments and the modifications thereof. The present invention may be embodied by combining all or some of the first to third embodiments and the modifications thereof.

The printing system, the image reading apparatus, and the control method therefor according the present invention are applicable to printing systems in general using an image reading apparatus and a printer. The present invention is particularly capable of performing print (copy) processing by cooperation between the image reading apparatus and the printer with a simple and inexpensive structure. Therefore, the printing system, the image reading apparatus, and the control method therefor according the present invention can be utilized effectively in offices and departments where copying jobs are performed frequently.

As described above, according to an aspect of the present invention, a printing system comprises an image reading apparatus that reads information from an original document; and a plurality of printers that performs printing based on the information read by the image reading apparatus, wherein the image reading apparatus comprises an image reading unit that reads information from the original document; a printer characteristics holding unit that holds functional characteristics information of the printers; a selecting unit that selects a printer most suitable for printing the information read by the image reading unit, based on the functional characteristics information of the printers held by the printer characteristics holding unit; a print data processing unit that prepares print data by writing the information read by the image reading unit in a page description language which can be interpreted by the selected printer; and an output control unit that sends the print data prepared by the print data processing unit to the printer selected by the selecting unit, and wherein the printer selected by the selecting unit receives the print data sent by the output control unit, interprets the page description language in the print data, and executes print processing.

According to another aspect of the present invention, the image reading apparatus further comprises a functional characteristics inquiry unit that inquires of the printers about the functional characteristics information; and the printer characteristics holding unit holds the result of the inquiry by the functional characteristics inquiry unit.

According to still another aspect of the present invention, the image reading apparatus further comprises a user authentication unit that performs authentication for users; and printer group information holding means which holds printer group information in correspondence to respective users, and wherein the selecting unit selects the most suitable printer with reference to the printer group information held by the printer group information holding means, on the basis of the user authenticated by the user authentication unit.

According to yet another aspect of the present invention, the image reading apparatus further comprises a status inquiry unit that inquires of the plurality of printers about status information thereof, and the selecting unit detects printers in the standby state based on the status information obtained by the status inquiry unit, and selects the most suitable printer from among the printers thus detected.

According to even another aspect of the present invention, the image reading unit comprises a color information determination unit that determines whether the information read from the original document is color or monochrome, and the selecting unit selects the most suitable printer based on the result of the determination by the color information determination unit.

According to further aspect of the present invention, the image reading unit comprises an original document size detection unit that detects size information of the original document, and the selecting unit selects the most suitable printer based on the size information detected by the original document size detection unit.

According to still further aspect of the present invention, an image reading apparatus which is connected to a plurality of printers and reads information from an original document, comprises an image reading unit that reads information from the original document; a printer characteristics holding unit that holds functional characteristics information of the printers; a selecting unit that selects a printer most suitable for printing the information read by the image reading unit based on the functional characteristics information of the printers held by the printer characteristics holding unit; a print data processing unit that prepares print data by writing the information read by the image reading unit in a page description language which can be interpreted by the selected printer; and an output control unit that sends the print data prepared by the print data processing unit to the printer selected by the selecting unit.

According to still further aspect of the present invention, a control method for a printing system having an image reading apparatus that reads information from an original document; and a plurality of printers that performs printing based on the information read by the image reading apparatus, comprises reading, by an image reading unit, information from the original document; holding, a printer characteristics holding unit, functional characteristics information of the printers; selecting, by a selecting unit, a printer most suitable for printing the information read by the image reading unit, based on the functional characteristics information of the printers held by the printer characteristics holding unit; preparing, by a print data processing unit, print data by writing the information read by the image reading unit in a page description language which can be interpreted by the selected printer; sending, by an output control unit, the print data prepared by the print data processing unit to the printer selected by the selecting unit; receiving, by the printer selected by the selecting unit, the print data sent by the output control unit; interpreting, by the printer, the page description language in the print data; and executing print processing by the printer.

The forgoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The entire disclosure of Japanese Patent Application No.2005-84172 filed on Mar. 23, 2005 including specification, claims, drawings and abstract is incorporated herein by reference in its entirety.

What is claimed is:

1. A printing system comprising:
an image reading apparatus that reads information from an original document; and
a plurality of printers that performs printing based on the information read by the image reading apparatus, wherein
the image reading apparatus comprises:
an image reading unit that reads information from the original document;
a printer characteristics holding unit that holds functional characteristics information of the printers;
a selecting unit that selects a printer most suitable for printing the information read by the image reading unit, based on the functional characteristics information of the printers held by the printer characteristics holding unit;
a print data processing unit that prepares print data by writing the information read by the image reading unit in a page description language which can be interpreted by the selected printer; and
an output control unit that sends the print data prepared by the print data processing unit to the printer selected by the selecting unit, and wherein
the printer selected by the selecting unit receives the print data sent by the output control unit, interprets the page description language in the print data, and executes print processing.

2. The printing system according to claim 1, wherein
the image reading apparatus further comprises a functional characteristics inquiry unit that inquires of the printers about the functional characteristics information; and
the printer characteristics holding unit holds the result of the inquiry by the functional characteristics inquiry unit.

3. The printing system according to claim 1, wherein
the image reading apparatus further comprises:
a user authentication unit that performs authentication for users; and
printer group information holding means which holds printer group information in correspondence to respective users, and wherein
the selecting unit selects the most suitable printer with reference to the printer group information held by the printer group information holding means, on the basis of the user authenticated by the user authentication unit.

4. The printing system according to claim 1, wherein
the image reading apparatus further comprises a status inquiry unit that inquires of the plurality of printers about status information thereof, and
the selecting unit detects printers in the standby state based on the status information obtained by the status inquiry unit, and selects the most suitable printer from among the printers thus detected.

5. The printing system according to claim 1, wherein
the image reading unit comprises a color information determination unit that determines whether the information read from the original document is color or monochrome, and
the selecting unit selects the most suitable printer based on the result of the determination by the color information determination unit.

6. The printing system according to claim 1, wherein
the image reading unit comprises an original document size detection unit that detects size information of the original document, and
the selecting unit selects the most suitable printer based on the size information detected by the original document size detection unit.

7. An image reading apparatus which is connected to a plurality of printers and reads information from an original document, comprising:
an image reading unit that reads information from the original document;
a printer characteristics holding unit that holds functional characteristics information of the printers;
a selecting unit that selects a printer most suitable for printing the information read by the image reading unit based on the functional characteristics information of the printers held by the printer characteristics holding unit;
a print data processing unit that prepares print data by writing the information read by the image reading unit in a page description language which can be interpreted by the selected printer; and
an output control unit that sends the print data prepared by the print data processing unit to the printer selected by the selecting unit.

8. A control method for a printing system having an image reading apparatus that reads information from an original document; and a plurality of printers that performs printing based on the information read by the image reading apparatus, comprising:
reading, by an image reading unit, information from the original document;
holding, a printer characteristics holding unit, functional characteristics information of the printers;
selecting, by a selecting unit, a printer most suitable for printing the information read by the image reading unit, based on the functional characteristics information of the printers held by the printer characteristics holding unit;
preparing, by a print data processing unit, print data by writing the information read by the image reading unit in a page description language which can be interpreted by the selected printer;
sending, by an output control unit, the print data prepared by the print data processing unit to the printer selected by the selecting unit; receiving, by the printer selected by the selecting unit, the print data sent by the output control unit;
interpreting, by the printer, the page description language in the print data; and
executing print processing by the printer.
